(19) United States
(12) Patent Application Publication
(10) Pub. No.: US 2007/0101541 A1
(43) Pub. Date: May 10, 2007

(54) HINGE ASSEMBLY FOR PORTABLE ELECTRONIC DEVICES

(75) Inventors: Gang Yin, Shenzhen (CN); Hsiao-Hua Tu, Tu-Cheng (TW); Chia-Hua Chen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: SHENZHEN FUTAIHONG PRECISION INDUSTRIAL CO., LTD., Shenzhen (CN); SUTECH TRADING LIMITED, Tortola (VG)

(21) Appl. No.: 11/309,568

(22) Filed: Aug. 24, 2006

(30) Foreign Application Priority Data
Nov. 4, 2005 (CN) 200510101035.5

(51) Int. Cl. E05D 7/00; H04M 1/00

(52) U.S. Cl. 16/221; 379/433.13

(57) ABSTRACT

A hinge assembly (200) includes a connecting member (10), two cams (30), two shafts (20), two elastic elements (40) and two barrels (50). The connecting member includes a first sleeve (12), a second sleeve (14) and a connecting sleeve (16) connected between. The first sleeve and the second sleeve each have respective partition boards (104, 144) formed therein. Each partition board includes a plurality of protrusions extending therefrom with a plurality of latching grooves formed between the protrusions. Each cam includes at least one latching block (32) and defines an axial hole (36). Each shaft has a shaft portion (24), and the shaft portion is configured for passing through the axial hole of each cam. Each elastic element provides an elastic force for each cam so as to hold the cam against the protrusions.

### FIELD OF THE INVENTION

The present invention relates to hinge assemblies and, more particularly, to a hinge assembly for foldable devices such as mobile telephones, portable computers, and so on.

### DESCRIPTION OF RELATED ART

With the development of wireless communication and information processing technologies, portable electronic devices such as mobile phones and personal digital assistants (PDA) are appearing in abundance, and consumers can now enjoy the full convenience of high technology anytime and anywhere.

Portable electronic devices includes several types such as bar type, flip type and folder type so as to satisfy different tastes of different people. A bar type mobile phone, since its keypad is exposed, can easily be damaged or the keypad can be pressed by mistake. A flip type mobile phone, although it was introduced to solve this problem and equipped with a flip to protect the keypad by covering it, shares another problem with the bar type mobile phone that its main body is still too long for convenient transport. Furthermore, the flip type mobile phone fails to satisfy the demand for a larger display screen required for internet access, etc. Thus, a folder type mobile phone has been introduced to shorten the length of the main body of a bar type phone or a flip type phone. However, the hinges that connect the cover and the housing can only open 150 degrees. The folder type mobile phone cannot be opened 180 degrees like a bar type mobile.

Therefore, a new hinge assembly and a portable electronic device therewith are desired in order to overcome the above-described problems.

### SUMMARY OF THE INVENTION

One embodiment of the present hinge assembly includes a connecting member, two cams, two shafts and two elastic elements. The connecting member includes a first sleeve, a second sleeve and a connecting sleeve connected between the first sleeve and the second sleeve. The first sleeve and the second sleeve each have a partition board formed therein. Each partition board includes a plurality of protrusions extending therefrom with a plurality of latching grooves formed between the protrusions. Each cam has at least one latching block and defines an axial hole. Each shaft has a shaft portion. The shaft portion is structured and arranged for passing through the axial hole of each cam and rotating together with each cam. Each elastic element provides an elastic force for each cam so as to hold the cam against a corresponding partition board.

Other advantages and novel features of the present hinge assembly will become more apparent from the following detailed description when taken in conjunction with the accompanying drawings.

### BRIEF DESCRIPTION OF THE DRAWINGS

Many aspects of the hinge assembly can be better understood with reference to the following drawings. The components in the drawings are not necessarily drawn to scale, the emphasis instead being placed upon clearly illustrating the principles of the present hinge assembly. Moreover, in the drawings, like reference numerals designate corresponding parts throughout the several views.

FIG. 1 is an exploded, isometric view of an embodiment of the present hinge assembly, as used in a mobile phone;

FIG. 2 is an exploded, isometric view of the embodiment of the hinge assembly shown in FIG. 1;

FIG. 3 is an enlarged view of the connecting member in FIG. 2;

FIG. 4 is a side view of the connecting member in FIG. 3;

FIG. 5 is an enlarged view of the cam in FIG. 2;

FIG. 6 is an enlarged view of the barrel in FIG. 2;

FIG. 7 is a partially cross-sectional view of the hinge assembly in FIG. 2;

FIG. 8 is an isometric view of the mobile phone in a position corresponding to a closed state;

FIG. 9 is a cut-away view of FIG. 8 along the line IX-IX;

FIG. 10 is an isometric view of the mobile phone in a position corresponding to being opened to 90 degrees;

FIG. 11 is a cut-away view of FIG. 10 along the line XI-XI;

FIG. 12 is an isometric view of the mobile phone in a position corresponding to being opened to 180 degrees; and

FIG. 13 is a cut-away view of FIG. 12 along the line XIII-XIII.

### DETAILED DESCRIPTION OF THE EMBODIMENTS

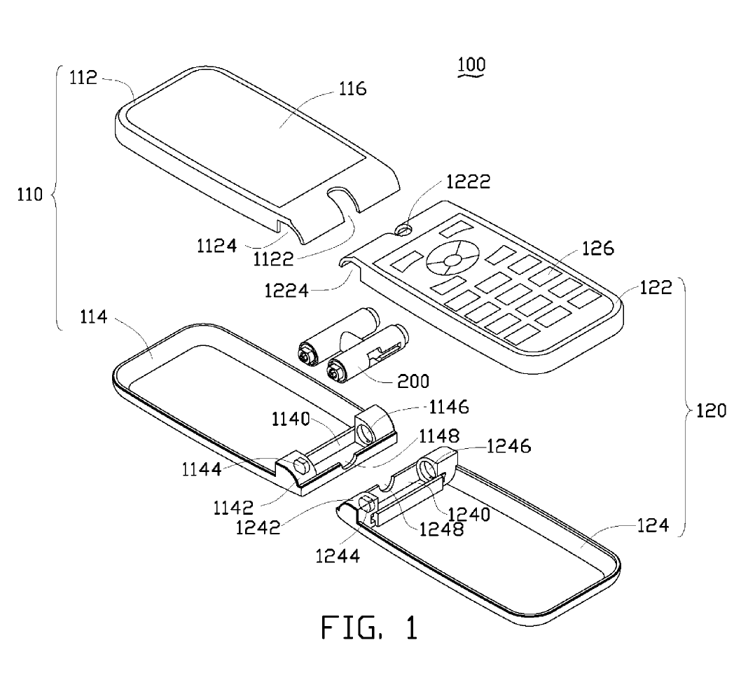

Referring now to the drawings in detail, FIG. 1 shows a hinge assembly 200, applied to a foldable electronic device such as a folder type mobile phone 100, for pivotably coupling a cover 110 and a housing 120. Although proving particularly advantageous when used in foldable electronic devices, the hinge assembly 200 should not be considered limited in scope solely to an intended use environment of foldable electronic devices.

The cover 110 includes an upper cover 112 and a lower cover 114. The upper cover 112 and the lower cover 114 are each substantially a rectangular cavity with an open side, and may be clasped together so as to form the cover 110.

The upper cover 112 defines an arcuate cutout 1122 at one end thereof, which communicates the end of the upper cover 112. The upper cover 112 has a display 16 for showing information on an upper surface thereof. Adjacent to the arcuate cutout 1122, the upper cover 112 defines a receiving groove 1124 opposite to the display 116. The receiving groove 1124 is substantially semi-circular.

The lower cover 114 forms two symmetrically fixed cylinders 1142 at one end thereof. Each fixed cylinder 1142 is substantially cylindrical, and the two fixed cylinders 1142 are positioned opposite to each other. One of the fixed cylinders 1142 defines a reverse rotating groove 1144 with non-circular shape. The other of the fixed cylinders 1142 defines a rotating groove 1146 with a circular shape. A rectangular cavity 1140 is defined between the two fixed cylinders 1142. An arcuate groove 1148 is defined at one end of the lower cover 114, and communicates the cavity 1140.

The housing 120 includes an upper housing 122 and a lower housing 124. The upper housing 122 and the lower housing 124 are respectively substantially a rectangular cavity with an open side, and may be clasped each other so as to form the housing 120. The upper housing 122 has a keypad 126 for inputting information.

The upper housing 122 defines an arcuate cutout 1222 at one end thereof, which communicates with the end of the upper housing 122. Adjacent to the arcuate cutout 1222, the upper housing 122 defines a receiving groove 1224 opposite to the keypad 126. The receiving groove 1224 is substantially semi-circular.

The lower housing 124 defines two symmetrically fixed cylinders 1242 at one end thereof. The cylinders 1242 are substantially cylindrical, and are positioned opposite to each other for engaging in the receiving groove 1224. One of the fixed cylinders 1242 defines a reverse rotating groove 1244 with non-circular shape. The other of the fixed cylinders 1242 defines a rotating groove 1246 with a circular shape. A rectangular cavity 1240 is defined between the two fixed cylinders 1242. An arcuate groove 1248 is defined at one end of the lower housing 124, and communicates with the cavity 1240.

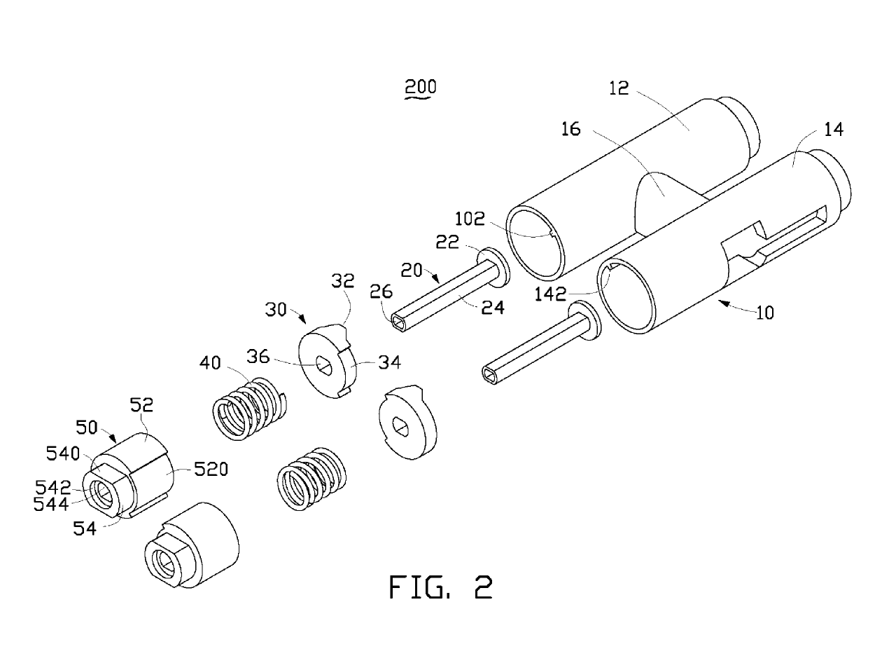

Referring to FIG. 2, the hinge assembly 200, in the embodiment illustrated, includes a connecting member 10, two shafts 20, two cams 30, two springs 40 and two barrels 50. The shafts 20, the cams 30, the springs 40 and the barrels 50 are received in the connecting member 10. The hinge assembly 200 is thus integrated into a whole.

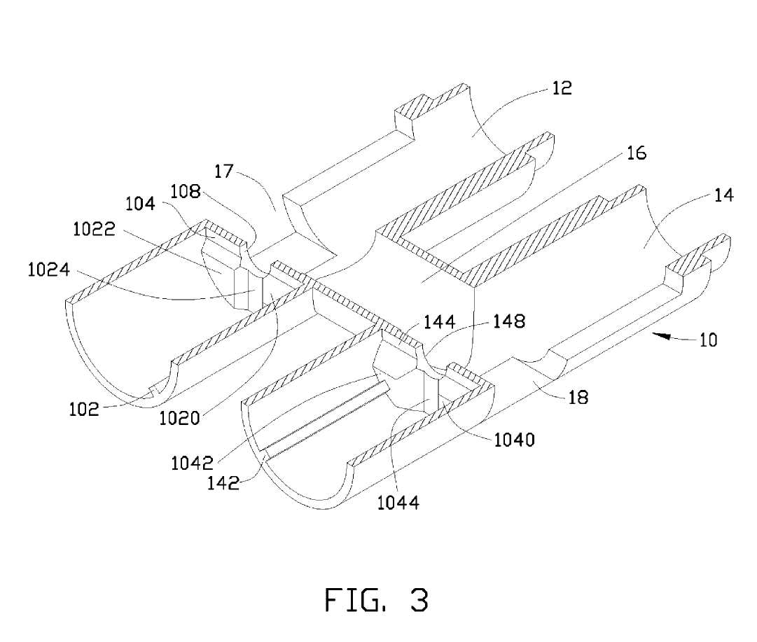

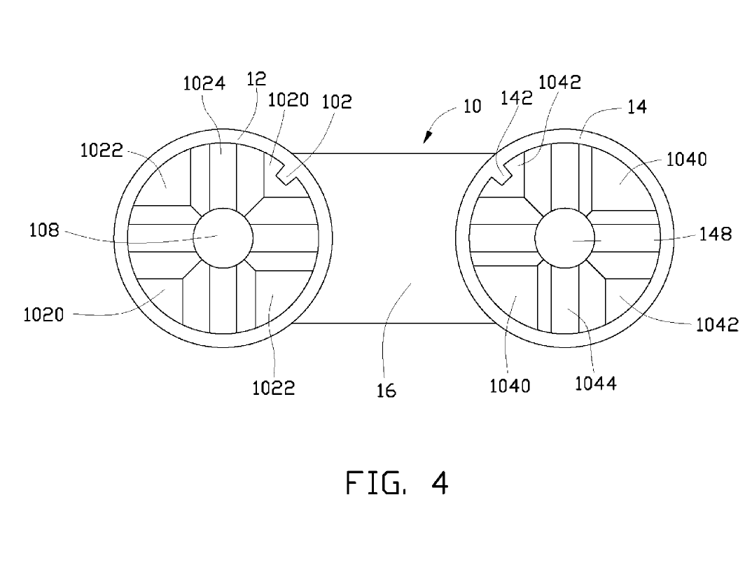

Referring also to FIGS. 3 and 4, the connecting member 10 is substantially H-shaped, and includes a first sleeve 12, a second sleeve 14 and a connecting sleeve 16 perpendicularly connected with each other. The first sleeve 12 is parallel to the second sleeve 14.

The first sleeve 12 is substantially a hollow cylinder. A partition board 104 is positioned in a middle of the first sleeve 12, thereby dividing the first sleeve 12 into two parts. The first sleeve 12 has a circular end for rotatably engaging in the rotating groove 1146. A limiting block 102 is formed in an inner peripheral wall of the first sleeve 12, and extends from an opposite end to the partition board 104 along an axis of the first sleeve 12. The partition board 104 forms two symmetrically opposite first protrusions 1020 and two symmetrically opposite second protrusions 1022. The first protrusions 1020 and the second protrusions 1022 are located around a periphery of the partition board 104, and intersect with the peripheral wall of the first sleeve 12. Each first protrusion 1020 and each second protrusion 1022 is substantially trapeziform in shape. A latching groove 1024 is defined between each first protrusion 1020 and each second protrusion 1022. An axial hole 108 is defined in a middle of the partition board 104.

The second sleeve 14 is substantially a hollow cylinder. The structure of the second sleeve 14 is similar to that of the first sleeve 12. A partition board 144 is positioned in a middle of the second sleeve 14, thereby dividing the second sleeve 14 into two parts. The second sleeve 14 has a circular end for rotatably engaging in the rotating groove 1246. A limiting block 142 is formed in an inner peripheral wall of the second sleeve 14, and extends from an opposite end to the partition board 144 along an axis of the second sleeve 14. The partition board 144 forms two symmetrically opposite third protrusions 1040 and two symmetrically opposite fourth protrusions 1042. The third protrusions 1040 and the fourth protrusions 1042 are located around a periphery of the partition board 144, and intersect with the peripheral wall of the second sleeve 14. Each third protrusion 1040 and each fourth protrusion 1042 is substantially trapeziform in shape. A latching groove 1044 is defined between each third protrusion 1040 and each fourth protrusion 1042. An axial hole 148 is defined in a middle of the partition board 144.

The height of the first protrusions 1020, the second protrusions 1022, the third protrusions 1040 and the fourth protrusions 1044 are respectively defined as “H1”, “H2”, “H3”, “H4”. “H1”, “H2”, “H3” and “H4” are related by the equation:
H4=H1>H2>H3.

The connecting sleeve 16 is substantially hollow cylinder, and perpendicularly communicates the first sleeve 12 and the second sleeve 14 and vice-versa. The first sleeve 12 and the second sleeve 14 respectively define a wire groove 17, 18 adjacent to a corresponding partition board 104, 144. The wire grooves 17 and 18 are used as a passage allowing wires to connect the cover 110 and the housing 120.

Each shaft 20 includes a flange portion 22 and a shaft portion 24. The flange portion 22 is substantially disk-like in shape, and is positioned at one end of the shaft portion 24. The shaft portion 24 is a deformable shaft structure, and is formed by cutting two flat surfaces. One end of the shaft portion 24 opposite to the flange portion 22 defines a fixed hole 26.

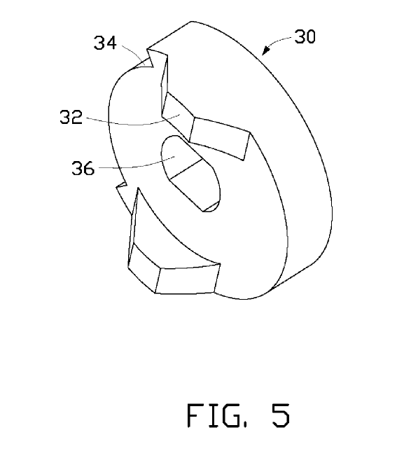

Referring also to FIG. 5, each cam 30 is substantially disk-like in shape. Each cam 30 has two latching blocks 32 formed at one end thereof. Each latching block 32 is substantially trapeziform in shape so as to engage in corresponding latching grooves 1024, 1044. Each cam 30 defines a positioning groove 34 at a peripheral wall thereof. The positioning groove 34 is located at the same side of the two latching blocks 32. The positioning groove 34 is arcuate, and the arcuate angle is 90 degrees. Each cam 30 defines a through hole 36 with an elliptical shape in a central area thereof. The size and the shape of the through hole 36 conform with those of the shaft portion 24.

Each spring 40 is a cylindrical spring. An inner diameter of each spring 40 is larger than an outer diameter of each shaft portion 24, thereby allowing each spring 40 to be placed around a corresponding shaft portion 24 of each shaft 20.

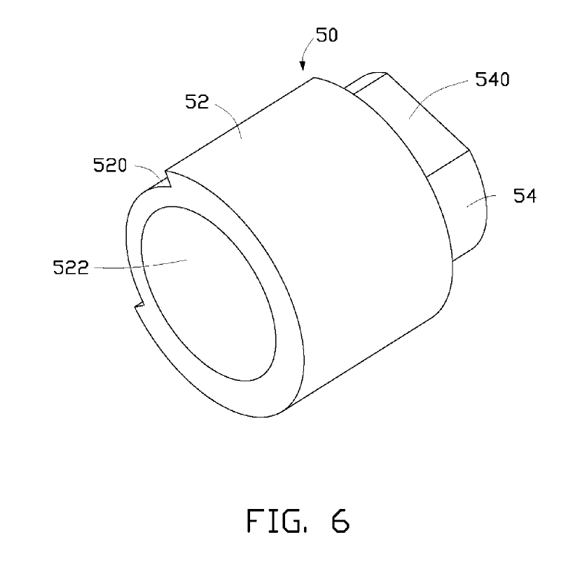

Referring also to FIG. 6, each barrel 50 includes a cylindrical portion 52 and a fixing portion 54 connected to each other. The cylindrical portion 52 defines a limiting groove 520 at a peripheral wall thereof. The limiting groove 520 is substantially arcuate, with an angle of 90 degrees between one end and the other. The cylindrical portion 52 defines a receiving hole 522 at one end thereof opposite to the fixing portion 540 and is used for receiving a corresponding spring 40. The fixing portion 54 is a deformable shaft. An outer peripheral diameter of the fixing portion 54 is smaller than an outer diameter of the cylindrical portion 52, thereby forming a step between them. The fixing portion 54 defines two flat surfaces 540 so that the fixing portion 54 may be engaged in the reverse rotating groove 1144 of the cover 110 or the reverse rotating groove 1244 of the housing 120, and rotates together with the cover 110 or the housing 120. The fixing portion 54 defines an end hole 542 and a deformable hole 544 opposite to the cylindrical portion 52. The deformable hole 544 communicates with the receiving hole 522.

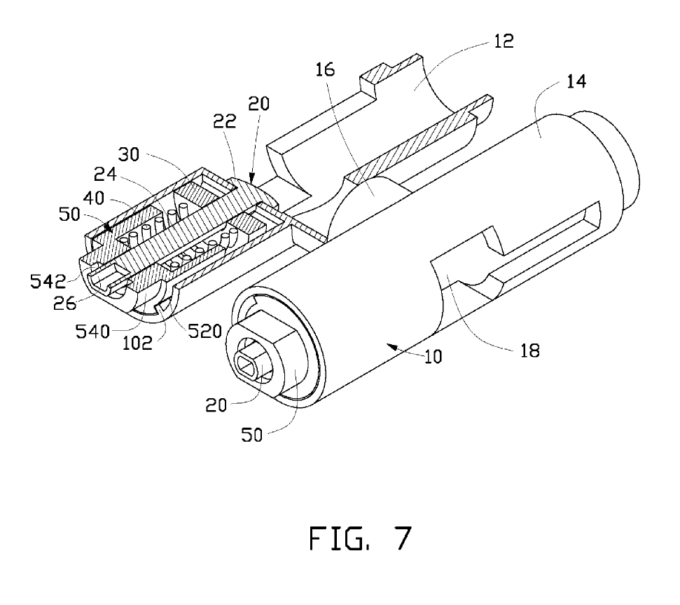

In assembly, referring to FIG. 7, firstly, the shaft portion 24 of one shaft 20 passes through the axial hole 108 of the partition board 104 of the first sleeve 12, and the flange portion 22 resists one side of the partition board 104 opposite to the protrusions 1020, 1022. Then, the shaft portion 24 is inserted into the through hole 36 of one cam 30, one spring 40, the receiving hole 522, the deformable hole 544 and the end hole 542 of one barrel 50 in that order. Thus, the cam 30, the spring 40 and the barrel 50 are received in the first sleeve 12. Owing to the deformable shaft portion 24, the shaft portion 22 may limit the rotation of the cam 30 and the barrel 50. Each latching block 32 engages in a corresponding latching groove 1024, and the limiting block 102 of the first sleeve 12 engages in the positioning groove 34 of the cam 30 and the limiting groove 520 of the barrel 50. Finally, the shaft 20 is fixed at a distal end by expanded joint so as to connect the above elements. The assembled process of the second sleeve 14 is similar to that of the first sleeve 12. Thus, the assembled process is not detailed. Accordingly, the hinge assembly 200 is thus completely assembled.

The assembled hinge assembly 200 is assembled into the foldable electronic device 100. Firstly, the lower cover 114 is positioned opposite to the lower housing 124, with the fixed cylinder 1142 opposite to the fixed cylinder 1242. Next, the first sleeve 12 of the hinge assembly 200 is received in the cavity 1140 of the lower cover 114, and the second sleeve 14 is received in the cavity 1240 of the lower housing 124. The two ends of the connecting sleeve 16 respectively engage in corresponding arcuate grooves 1148, 1248 so as to connect the lower cover 114 and the lower housing 124. At the same time, the fixed portion 54 of each barrels 50 engages in a given reverse rotating groove 1144 or 1244, and the circular ends of the first sleeve 12 and the second sleeve 14 are respectively received in their corresponding rotating grooves 1146, 1246. After that, printed circuit boards are received in the foldable electronic device 100. Wires pass through the wire groove 17, 18 of the connecting member 10 so as to electronically connect the cover 110 and the housing 120. Finally, the receiving groove 1124 of the upper cover 112 receives the fixed cylinders 1142, and one end of the connecting sleeve 16 engages in the cutout 1122. Thus, the upper cover 112 covers the lower cover 114. The receiving groove 1224 of the upper housing 122 receives the fixed cylinders 1242, and the other end of the connecting sleeve 16 engages in the cutout 1222. Thus, the upper housing 122 covers the lower housing 124. Accordingly, the assembled process of the foldable electronic device 100 is finished.

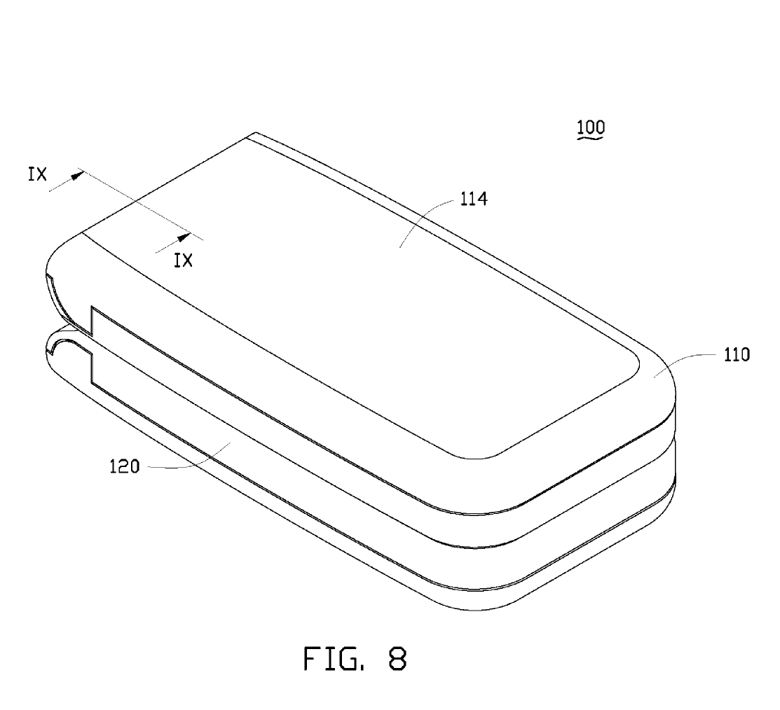

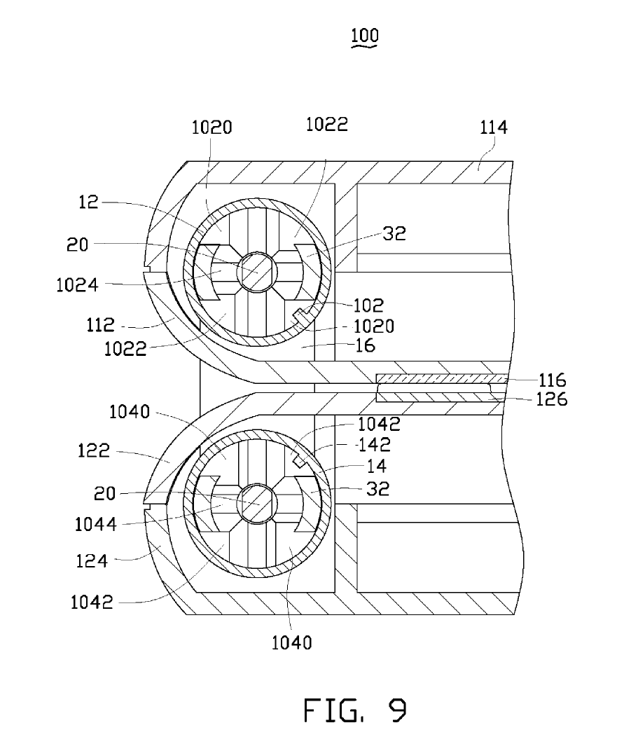

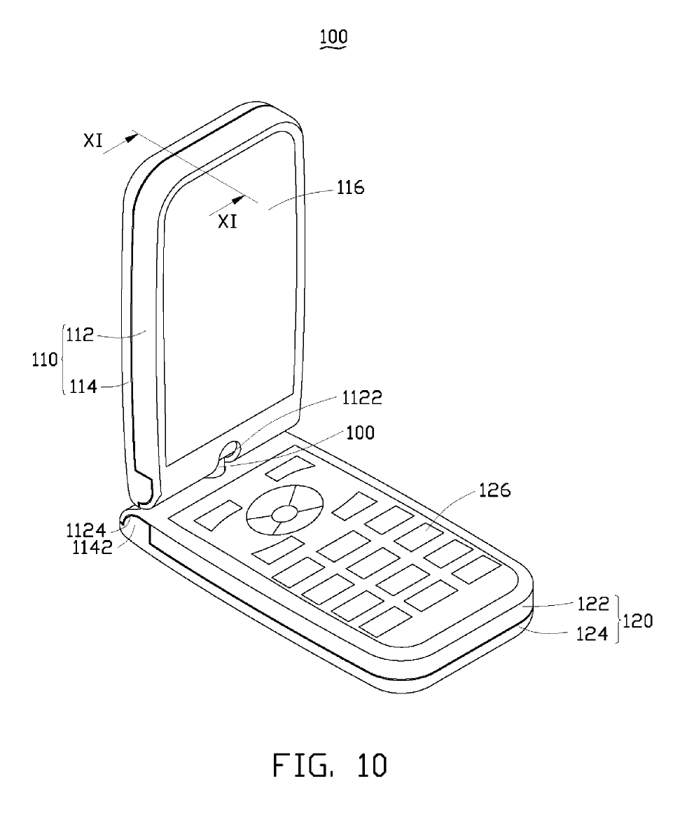

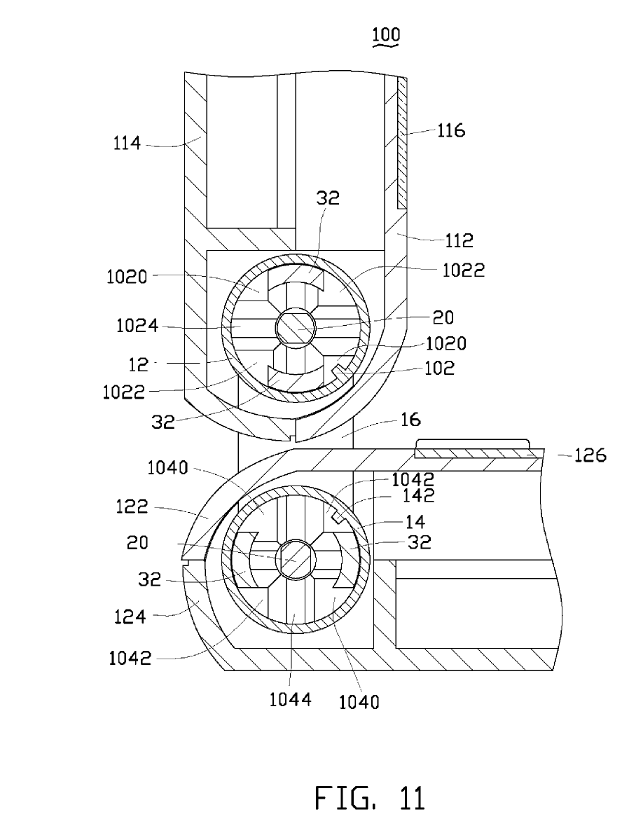

Referring to FIGS. 8 and 9, when the cover 110 is closed relative to the housing 120, the latching blocks 32 of the cam 30 of the first sleeve 12 and the second sleeve 14 are respectively engaged in the latching grooves 1024, 1044. Referring to FIGS. 10 and 11, if the cover 110 is opened relative to the housing 120, the cover 110 firstly brings the barrel 50 in the first sleeve 12 to rotate because the heights of the first protrusions 1020, the second protrusions 1022, the third protrusions 1040 and the fourth protrusions 1044 are related by the equation H4=H1>H2>H3. The barrel 50 further brings the shaft 20 to rotate. Thus, the shaft 20 makes the cam 30 rotate together therewith. Owing to the first protrusions 1020 being larger than the second protrusions 1022, the latching blocks 32 of the cam 30 rotate counter-clockwise relative to the first sleeve 12. Thus, the latching blocks 32 slide away from the latching grooves 1024, and pass over the second protrusion 1022. Accordingly, the latching blocks 32 are engaged in the next latching groove 1024 between the first protrusion 1020 and the second protrusion 1022. At the same time, the limiting block 102 of the first sleeve 12 rotates 90 degrees in the positioning groove 34 of the cam 30 and the limiting groove 520 of the barrel 50. Thus, the cover 110 is opened 90 degrees relative to the housing 120. Owing to the limiting block 102, the cover 110 is kept at 90 degrees.

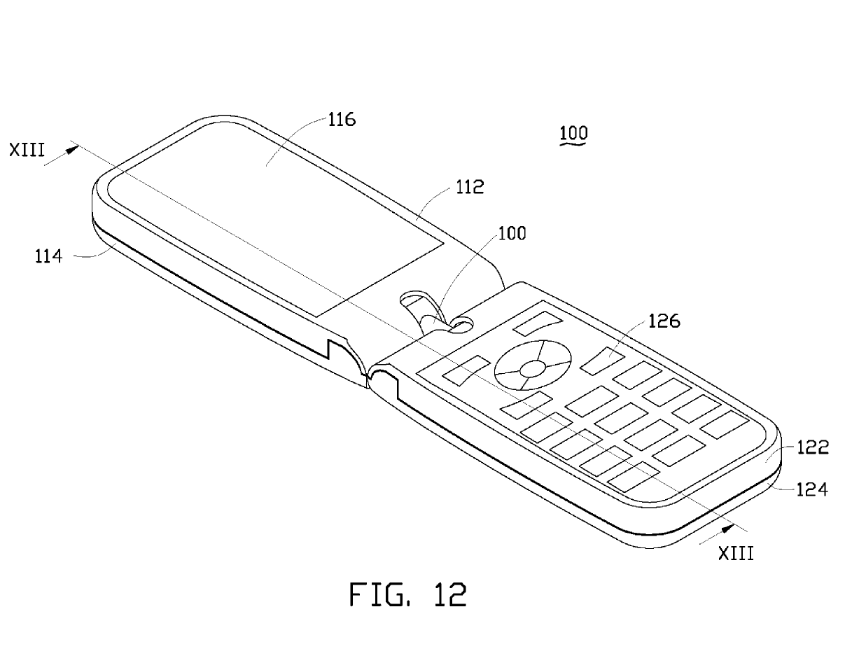

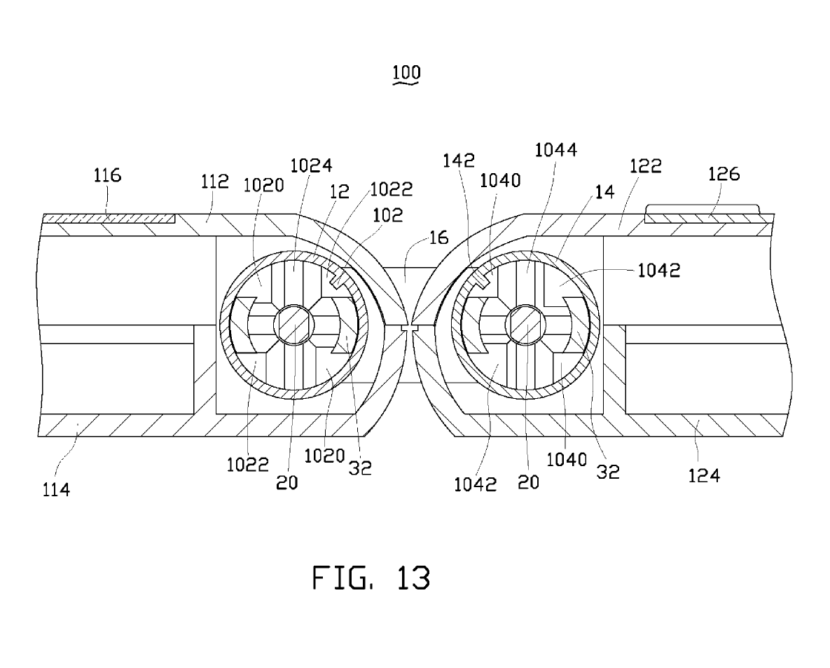

If the cover 180 is opened to 180 degrees, referring to FIGS. 12 and 13, the limiting block 102 of the first sleeve 12 limits the rotation of the cam 30. Thus, the latching block 32 of the second sleeve 14 slides away from the latching groove 1044. Owing to the third protrusions 1040 being smaller than the fourth protrusions 1042, the latching block 32 passes through the third protrusion 1040, and is engaged in the latching groove 1044 between the fourth protrusion 1042 and the third protrusion 1040. At the same time, the limiting block 142 of the second sleeve 14 rotates 90 degrees in both the positioning groove 34 of the cam 30 and the limiting groove 520 of the barrel 50. Thus, the housing 120 is opened 90 degrees relative to the cover 110. Owing to the limiting block 102, the housing 120 is kept in 180 degrees state relative to the cover 110.

The principles of the closing process are basically the same as the cover 110 of the foldable electronic device 100 is opened. Thus, the closing process is not detailed.

In an alternative embodiment, the receiving hole 522 of the barrel 50 may be omitted. Accordingly, the spring 40 directly resists an end wall of the barrel 50.

In an alternative embodiment, the first protrusion 1020, the second protrusion 1022, the third protrusion 120 and the fourth protrusion 122 are not limited to being trapeziform in shape. Alternatively, the configuration may be replaced by concave and convex surfaces. The latching blocks 32 may also be replaced by other structures.

In an alternative embodiment, the height of the first protrusion 1020, the second protrusion 1022, the third protrusion 1040 and the fourth protrusion 1042 are not limited to the above relationship. Alternatively, the height of the first protrusion 1020 can be reversed to the second protrusion 1022. Then, the housing 120 is firstly opened to an angle of 90 degrees relative to the cover 110, and the cover 110 is further opened to an angle of 90 degrees relative to the housing 120.

Understandably, the connecting member may includes a first connecting portion configured so as to be rotatably received in the housing, a second connecting portion configured so as to be rotatably received in the cover, and a third connecting portion connecting the first connecting portion with the second connecting portion in a manner such that the first connecting portion and the second connecting portion are non-removable relative to each other. The first connecting portion and the second connecting portion respectively define a first rotation axis and a second rotation axis that are parallel to each other. A first rotation limiting unit is configured so as to be engaged between the first connecting portion and the housing in a manner so as to limit the housing to rotate within a first predetermined angle relative to the first rotating axis. A second rotation limiting unit is configured so as to be engaged between the second connecting portion and the cover in a manner so as to limit the cover to rotate within a second predetermined angle relative to the second rotating axis.

As described above, the hinge assembly 200 may be opened to an angle of 90 degrees so as to view the information on the display 116. Moreover, the foldable electronic device 100 may be also opened to an angle of 180 degrees. Accordingly, the foldable electronic device 100 is like a bar type mobile phone when opened. Therefore, the foldable electronic device combines the advantages of the bar type mobile phone and the foldable type mobile phone. Understandably, the angle of 90 degrees may be variable, and be replaced by other angles.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hinge assembly, comprising:
a connecting member comprising a first sleeve, a second sleeve and a connecting sleeve connected between the first sleeve and the second sleeve, the first sleeve and the second sleeve respectively having a partition board formed therein, each partition board having a plurality of protrusions extending therefrom with a plurality of latching grooves formed between the protrusions;
two cams, each cam having at least one latching block and defining an axial hole, the at least one latching block engaging in a corresponding latching groove; two shafts, each shaft having a shaft portion, the shaft portion being structured and arranged for passing through the axial hole of each cam for rotating together with the cam; and
two elastic elements, each elastic element providing an elastic force for each cam so as to hold each cam against a corresponding partition board.

2. The hinge assembly as claimed in claim 1, wherein the protrusions include two first protrusions, two second protrusions, two third protrusions and two fourth protrusions, where the partition board of the first sleeve includes the two first protrusions and the two second protrusions, and the partition board of the second sleeve includes the two third protrusions and the two fourth protrusions.

3. The hinge assembly as claimed in claim 2, wherein a height of the first protrusions, the second protrusions, a third protrusions and the fourth protrusions are respectively defined as “H1”, “H2”, “H3”, “H4”, and the heights of the first protrusions, the second protrusions, the third protrusions and the fourth protrusions are related by the equation H4=H1>H2>H3.

4. The hinge assembly as claimed in claim 2, wherein the first protrusion, the second protrusion, the third protrusion and the fourth protrusion are trapeziform in shape.

5. The hinge assembly as claimed in claim 1, wherein the connecting sleeve is a hollow cylinder, the first sleeve is parallel to the second sleeve, the connecting sleeve is perpendicularly connected with the second sleeve and the first sleeve, and the connecting sleeve communicates the first sleeve with the second sleeve and vice-versa.

6. The hinge assembly as claimed in claim 1, wherein the shaft further comprises a flange portion, the flange portion is located at one end of the shaft portion, the shaft portion is a deformable shaft structure formed by cutting two flat surfaces, and one end of the shaft portion at an opposite end to the flange portion defines a fixed hole.

7. The hinge assembly as claimed in claim 1, further comprising two barrels, each barrel receiving a corresponding elastic element, wherein each barrel includes a cylindrical portion and a fixing portion, and the cylindrical portion defines a limiting groove at a peripheral wall thereof, the first sleeve and the second sleeve include a limiting block for engaging in a corresponding limiting groove, and the limiting groove is arcuate with an angle of 90 degrees between one end and the other.

8. The hinge assembly as claimed in claim 7, wherein the cylindrical portion defines a receiving hole at one end thereof opposite to the fixing portion for receiving a corresponding elastic element.

9. The hinge assembly as claimed in claim 8, wherein the fixing portion is a deformable shaft, an outer peripheral diameter of the fixing portion is smaller than an outer diameter of the cylindrical portion, thereby forming a step, the fixing portion defines an end hole and a deformable hole, and the deformable hole communicates the receiving hole, each shaft passing through the receiving hole, the end hole and the deformable hole.

10. A hinge assembly of a foldable electronic device comprising a housing and a cover, the hinge assembly comprising:
a connecting member including a first connecting portion configured so as to be rotatably received in the housing, a second connecting portion configured so as to be rotatably received in the cover, and a third connecting portion connecting the first connecting portion with the second connecting portion in a manner such that the first connecting portion and the second connecting portion are non-removable relative to each other, the first connecting portion and the second connecting portion respectively defining a first rotation axis and a second rotation axis that are parallel to each other;
a first rotation limiting unit configured so as to be engaged between the first connecting portion and the housing in a manner so as to limit the housing to rotate within a first predetermined angle relative to the first rotating axis; and
a second rotation limiting unit configured so as to be engaged between the second connecting portion and the cover in a manner so as to limit the cover to rotate within a second predetermined angle relative to the second rotating axis.

11. The hinge assembly as claimed in claim 10, wherein the first predetermined angle plus the second predetermined angle equals 180 degrees.

12. The hinge assembly as claimed in claim 11, wherein the first and second predetermined angles are both 90 degrees.

13. The hinge assembly as claimed in claim 12, wherein the first and the second connecting portions are sleeves, rotation limiting units received in sleeves, the third connecting portion defines a passage allowing extending transmitting line of the foldable electronic device therethrough.

14. The hinge assembly as claimed in claim 13, wherein each rotation limiting unit includes a cam, a shaft and an elastic element, the cam and the elastic element placed around the shaft and received in a corresponding sleeve so as to allow the cover to rotate 90 degrees relative to the housing, and further allow the housing to rotate 90 degrees relative to the cover.

15. A foldable electronic device comprising:
a main body;
a foldable cover hinged to the main body by a hinge assembly to the cover, the hinge assembly comprising:
a connecting member structured and arranged for fixing to the main body and the foldable cover, the connecting member comprising a first sleeve, a second sleeve and a connecting sleeve connecting the first sleeve and the second sleeve, the first sleeve and the second sleeve having a partition board, each partition board including a plurality of protrusions extending therefrom and defining a plurality of latching grooves;
two cams, each cam including at least one latching block and defining an axial hole, the at least one latching block engaging in a corresponding latching groove;
two shafts, each shaft having a shaft portion, the shaft portion being configured for passing through the axial hole of each cam; and
two elastic elements, each elastic element providing an elastic force for each cam so as to hold each cam against its respective partition board.

16. The foldable electronic device as claimed in claim 15, wherein the protrusions include two first protrusions, two second protrusions, two third protrusions and two fourth protrusions, wherein the partition board of the first sleeve includes the two first protrusions and the two second protrusions, and the partition board of the second sleeve includes the two third protrusions and the two fourth protrusions.

17. The foldable electronic device as claimed in claim 16, wherein a height of the first protrusions, the second protrusions, a third protrusions and the fourth protrusions are respectively defined as “H1”, “H2”, “H3”, “H4”, wherein the heights of the first protrusions, the second protrusions, the third protrusions and the fourth protrusions are related by the equation H4=H1>H2>H3.

18. The foldable electronic device as claimed in claim 15, wherein the connecting sleeve is a hollow cylinder, the first sleeve is parallel to the second sleeve, the connecting sleeve is perpendicularly connected with the second sleeve and the first sleeve and communicates the first sleeve with the second sleeve and vice-versa.

19. The foldable electronic device as claimed in claim 17, further comprising two barrels, each barrel includes a cylindrical portion and a fixing portion, the cylindrical portion defines a limiting groove at a peripheral wall thereof, the limiting groove is substantially arcuate, with an angle of 90 degrees between one end and the other, and the cylindrical portion defines a receiving hole at one end thereof opposite to the fixing portion for receiving the elastic element.

20. The hinge assembly as claimed in claim 19, wherein the fixing portion is a deformable shaft, an outer peripheral diameter of the fixing portion is smaller than an outer diameter of the cylindrical portion, thereby forming a step, the fixing portion defines an end hole and a deformable hole, and the deformable hole communicates the receiving hole.
